(19) United States
(12) Patent Application Publication
(10) Pub. No.: US 2022/0237183 A1
(43) Pub. Date: Jul. 28, 2022

(54) METHOD AND SYSTEM FOR IDENTIFYING THE EXISTENCE OF MATCHED ENTITIES IN REACHABLE PROXIMITY

(71) Applicants: Niv Nissim, Ramat Gan (IL); Yehonatan Alfasi, Tel Aviv (IL)

(72) Inventors: Niv Nissim, Ramat Gan (IL); Yehonatan Alfasi, Tel Aviv (IL)

(21) Appl. No.: 17/571,487

(22) Filed: Jan. 9, 2022

Related U.S. Application Data
(60) Provisional application No. 63/141,499, filed on Jan. 26, 2021.

(51) Int. Cl. G06F 16/2457; G06F 16/28; G06F 16/21; G06F 16/215; G06F 1/16

(52) U.S. Cl. CPC G06F 16/2457; G06F 16/288; G06F 1/163; G06F 16/215; G06F 16/219

(57) ABSTRACT

The subject matter discloses a method, the method comprises: receiving a capture, the capture being captured by a sensor associated with a first computing device, the capture capturing an environment of the first computing device; identifying a first entity in the capture; querying, in a data repository, for a second entity the second entity being associated with the computing device; and transmitting a notification message to be presented in the first computing device, the message comprising the identification of the first entity; the transmitting being as a result of identifying a match between a first profile of the first entity and a second profile of the second entity

### FIELD OF THE INVENTION

The present disclosure relates to the field of digital matching in general and to digital matching associated with proximity, in particular.

### BACKGROUND OF THE INVENTION

A conference is a meeting of people with a common interest who wish to get together and to establish new connections. In some cases, the conference includes in exhibitions in which at least some of the parties present their products or their ideas to the participants.

### SUMMARY OF THE INVENTION

The term computing device refers herein to a device that includes a processing unit. Examples for such device are a personal computer, a laptop, a server, a tablet, a wearable device such as bracelet and smart glasses, a cellular device and IOT (internet of things) device.

The term entity refers herein to a person, a group of persons or an organization. In some cases, some of the entities are passive, that is to say do not try to pursue the other entities while some other entities are active in pursuing the match. Such other entities are termed herein as is a pursuer.

The subject matter discloses system and method for identifying the existence of matched entities in close proximity and for causing real time connection between entities.

In some embodiments the entities are located in a space associated with an event. The event is associated with time frame and with physical location. The event enables to connects entities match same preferences. The entities typically share the same area of interest. An example for such an event is an exhibition.

According to some embodiments the system collects data about the entities prior, or during the event. The system detects an arrival of an entity to the location of the event and finds relevant matching that may be based on predefined criteria for the entity.

The system notifies the entities about the match when the entities are in a reachable proximity.

The term reachable proximity refers herein to surrounding that is close enough to enable a certain entity to approach the other entity. The size of the reachable proximity may be defined by sensors used to capture the surrounding. The span of the reachable proximity may be up to 360 degrees. The diameter of the reachable proximity is typically 15 meters.

The notification about the match may include data that enables the certain entity to approach the other entity. In some cases, only the pursuer receives the notification about the match. In some other cases each entity receives the notification and may approach the other entity. According to some embodiments the system tracks the movement of the registered entities that participate in the event and provides statistics about the location of the participants. Such statistic may include, for example, average duration of staying in a booth of an exhibitor at a certain time, average number of entities located in a booth of an exhibitor at a certain time etc.

According to some embodiments the system provides a heat map which is generated based on the statistics about the matches that were found by the system. The heat map includes the location of the booth or venue that is associated with the match, and other data such as rate of success of the match etc.

In some aspects of the present invention relates to a non-transitory computer-readable medium comprising instructions which when executed by at least one processor causes the processor to perform the method of the present invention.

Embodiments of the invention may be implemented as a computer process (method), a computing system, or as an article of manufacture, such as a computer program product or a non-transitory computer-readable media. The computer program product may be a computer storage media readable by a computer system and encoding a computer program of instructions for executing a computer process on the computer and network devices. The computer program product may also be a propagated signal on a carrier readable by a computing system and encoding a computer program of instructions for executing a computer process.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a block diagram of a system for causing the real time connection between entities located in a space associated with an event, in accordance with some exemplary embodiments of the subject matter;

FIG. 2 shows a flowchart diagram for the process of registering to the system for causing the real time connection between entities located in a space associated with an event, in accordance with some exemplary embodiments of the disclosed subject matter;

FIG. 3 shows a flowchart diagram of a method for identifying an entity in a system, in accordance with some exemplary embodiments of the disclosed entity matter;

FIG. 4 shows a flowchart diagram of a method for matching entities and, in accordance with some exemplary embodiments of the disclosed subject matter;

FIG. 5 is a block diagram of an edge device of a system for causing the real time connection between entities located in a space associated with an event, in accordance with some exemplary embodiments of the subject matter; and

FIG. 6 shows an exemplary segmentation, in accordance with some exemplary embodiments of the subject matter.

### DETAILED DESCRIPTION

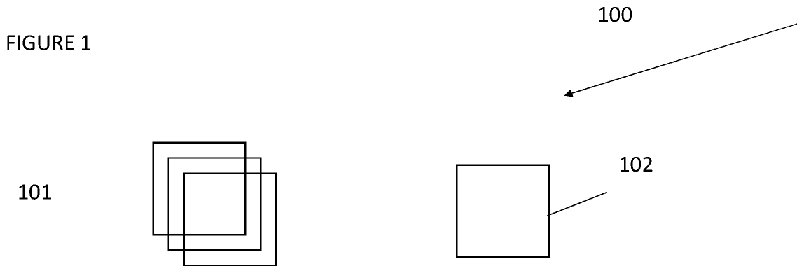

FIG. 1 shows a block diagram of a system for causing real time connection between entity located in a space associated with an event, in accordance with some exemplary embodiments of the subject matter.

System 100 includes a plurality of edge devices 101 and a back-end device 102.

The plurality of edge devices 101 are located in a plurality of locations of the area of the event. In some embodiments. The plurality of edge devices 101 are located in the vicinity of the pursuers. for example, in the area of a booth of an exhibitor. The plurality of edge devices 101 are configured for capturing captures of the surrounding and for notifying when a match between two entities that are in the same reachable proximity is identified. In some embodiments edge device 101 is configured for analyzing the capture for identifying a match between two entities that are in the same reachable proximity and for presenting the notifications to the user. In some other embodiments the analysis is performed by the back-end device 102.

In some embodiments an edge device 101 is a mobile device such as a robot or any other computing device. An example for such a robot is AWS DeepRacer, more advanced as the T-HR3 humanoid by the Toyota TM or equivalent

The back-end computing device 102 is configured for receiving the captures from the plurality of edge devices 101, for analyzing the capture and for identifying a match between two entities that are in the same reachable proximity. In some embodiment the back-end device 102 is a remote server.

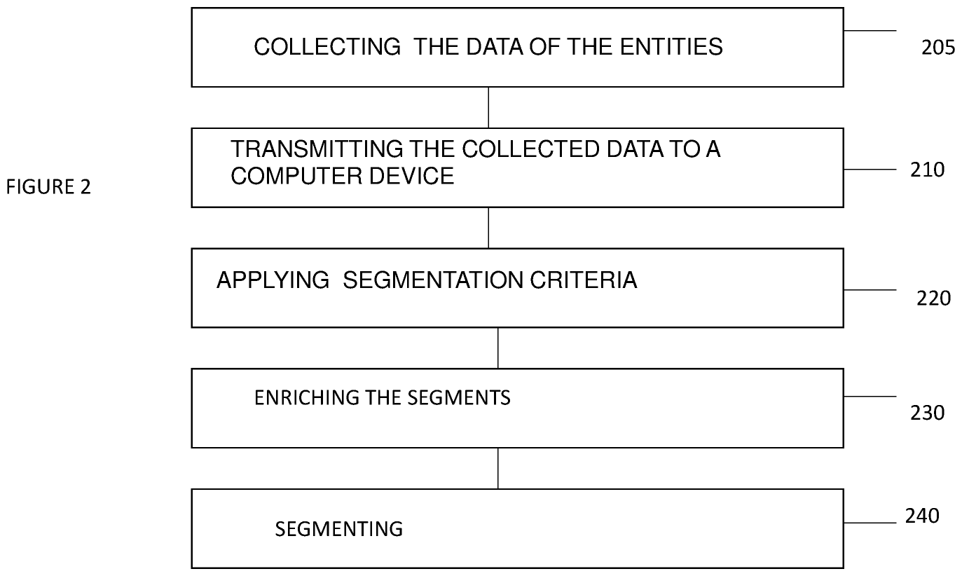

The operation of the plurality of edge devices 101 and the back-end device 102 are explained in greater details in FIGS. 2, 3, 4 and 5.

FIG. 2 shows a flowchart diagram for the process of registering to the system for causing the real time connection between entities located in a space associated with an event, in accordance with some exemplary embodiments of the subject matter

According to some embodiments the system collects data about the entities prior or during the event. The system detects an arrival of an entity to the location of the event, matches the data associated with the entity with data of other entities for finding relevant matching. The system identifies matched entities that are in a reachable proximity and notifies about the match.

Referring now to the drawing:

At block 205 the system collects the data of the entities that are scheduled to participate in the event. Such data may include profile. The profile may include personal information such as name, date of birth, occupation, employment information. Employment information may include sector, role, seniority level and location of the business, company name and position in a company. The data may be provided by the entity upon registration. The registration may be on site or prior to the event. If the entity is a company the system collects data associated with the company such data may include location, number of employees, industry etc.

Per each entity the system queries for the relevant contact profile. The relevant contact profile is the profile of the other entities that this entity would like to meet. For example, if the event is a conference, the entities may be companies who wish to sell. Such entities may and provide a profile of the relevant client. The client on the other side may define industry and industry segment of the companies that he wishes to meet at the event.

The data may also include a capture of a visual identification of the entity. The visual identification may be, for example face of a person or logo of a company.

At block 210 the system transmits the collected data to a back-end computer device. The data is stored in a data repository and is used in the matching process.

At block 220 the system applies segmentation criteria. The criteria may be associated with the event. For example, if the event is a conference related to electronic appliances, the segmentation can be according to the type of appliances e.g. refrigerators, ovens etc. The segmentation may also be according to geographic location of the entity, level in organization of the entity, etc.

At block 230 each segment may be enriched by information from third parties. Such third parties may be for example social networks. Enrichments may be performed by platforms such as the ZOOM INFO. The enrichment enables the matching algorithm to take into consideration more information and make more personalized matches that suit the pursuer needs.

At block 240 the data repository is segmented according to the segmentation criteria in order to provide an efficient match. The segmentation process narrows down the number of relevant records in the data repository and causes the matching process to be more efficiently and in real-time

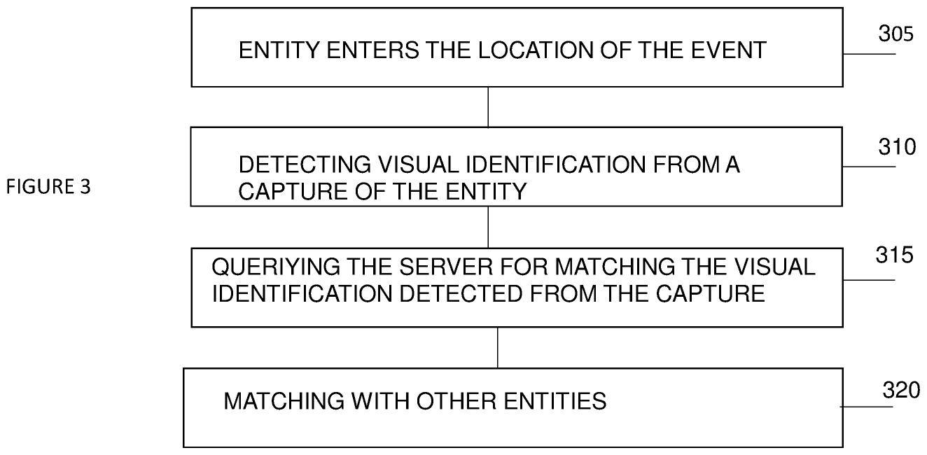

FIG. 3 shows a flowchart diagram of a method for identifying an entity in a system, in accordance with some exemplary embodiments of the disclosed entity matter.

At block 305 an entity enters the location of the event. As a result, a camera captures a capture of the visual identification of the entity.

At block 310 the capture is analyzed for detecting the visual identification. Analyzing may be performed by methods such as SSD (Single shot detection). Such SSD method may be the Res10_300×300_SSD_ITER or equivalent machine learning models.

At block 315 the system queries the back end for matching the visual identification detected from the capture with visual identification of registered entities that are stored in a data repository. In some cases, the query is also used for authenticating the entrance of the entity into the location of the event.

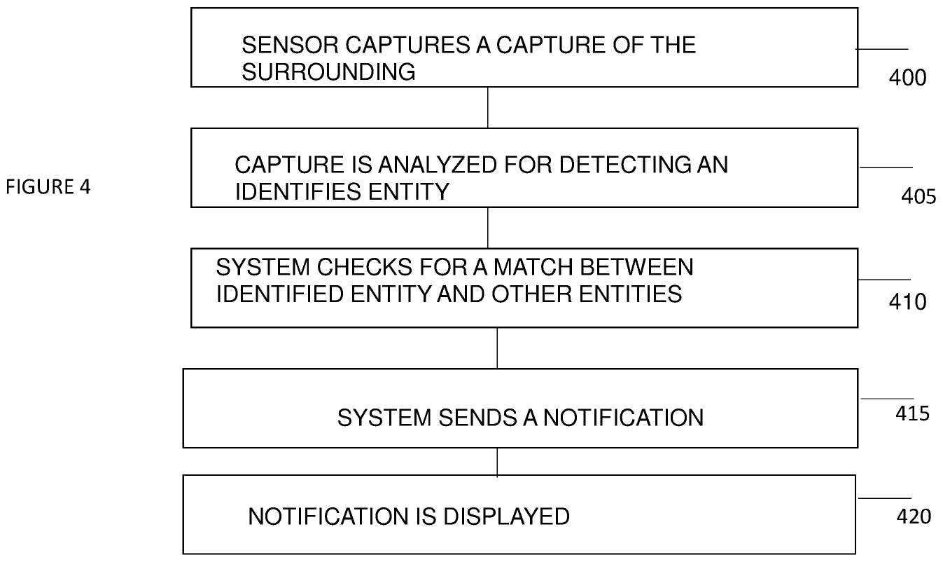

At block 320 which is performed if the entity is identified, the match with other entities is performed. The match is explained in greater details in FIG. 4.

FIG. 4 shows a flowchart diagram of a method for matching entities, in accordance with some exemplary embodiments of the disclosed subject matter.

According to some embodiments the system includes a plurality of edge devices. In some embodiments the edge devices are located in the vicinity of the pursuer entities; for example, if the event is an exhibition the edge devices may be located in the booths of the exhibitors. In some embodiments the edge devices is a mobile robot.

In some embodiments the sensor of the edge device periodically captures the surrounding. The captures are analyzed for detecting an identified entity in the capture. If such identified entity is detected, based on predefined criteria defined by the pursuer and or the exhibitor, the system checks if there is a match between the profile of the identified entity and the preferred-contact-profile of the pursuer associated with the edge device. In some embodiment the system also checks for a match between the preferred-contact-profile of the identified entity and the profile of the entity associated with the edge device. If a match is found the system notifies the computing device associated with the pursuer. In some embodiment the system may also notify the computing device of the identified entity.

Referring now to the drawing:

At block 400 the sensor captures a capture of the surrounding.

At block 405 the capture is analyzed for authenticating the entity. The authenticating is by identifying the entity as an identified entity an identifies entity. An identified entity is an entity that has been registered to the event and has been identified by the system. Detecting an identified entity may be performed by performing facial recognition and then matching the recognized face with the entities that are identified. In some embodiments the matched is performed by comparing digital signatures.

At block 410 which occurs if an identified entity is detected (that is to say the entity is authenticated) in the capture, the system checks for a match between the profile of the entity and the preferred-contact-profile of the pursuer associated with the edge device.

In some embodiment the system defines a preferred-contact profile for a non-pursuer entity. In such a case the system may also check for a match between the preferred-contact-profile of the identified entity and the profile of the entity associated with the edge device. For example: if the pursuer is a company that sells luxurious vehicles at an exhibition and the identified entity is a person looking for such a vehicle, a match is identified.

In some embodiments the match is performed by matching segments in the data repository that are associated with the profile of the entity and the relevant contact profile of the pursuer. In some embodiments each profile and each relevant contact profile is associated with a segment in the data repository.

At block 415 which occurs if a match is found, the system notifies the pursuer. Notification may be, for example, by messaging a mobile device of any other computing device associated with the pursuer. In some embodiment the system notifies the identified entity as well.

At block 420 the notification is displayed on the computing device of the pursuer. In some embodiment the notification is presented on the computing device of the identified entity as well.

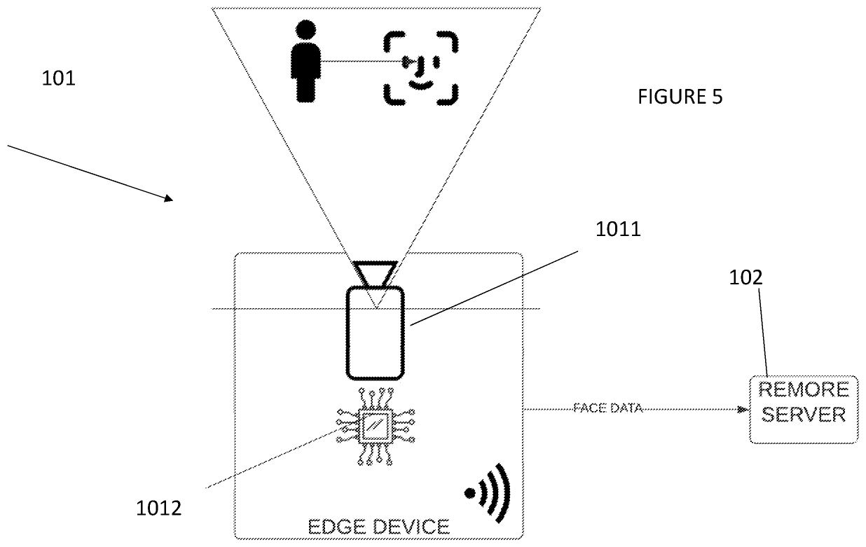

FIG. 5 is a block diagram of an edge device of a system for causing the real time connection between entities located in a space associated with an event, in accordance with some exemplary embodiments of the subject matter.

Edge device 101 includes a sensor 1011 and a processing unit 1012. The sensor 1011 may be a camera. The sensor is 1011 configuring for capturing captures of the surrounding of the edge device. The processing unit 1012 is configured for transferring the captures to the back-end device 102. In some other embodiments the processing unit 1012 analysis the capture for finding the match.

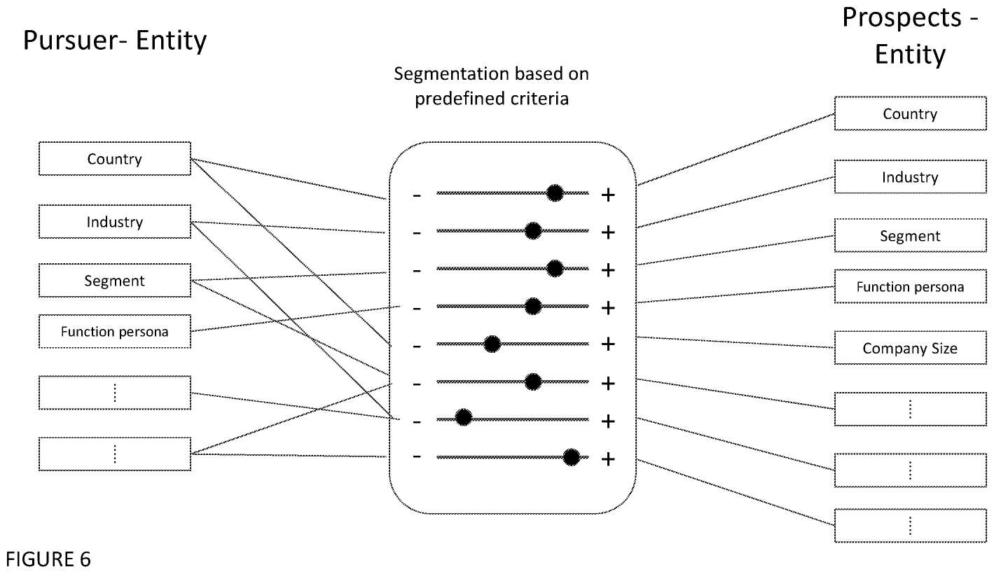

FIG. 6 shows an exemplary segmentation, in accordance with some exemplary embodiments of the subject matter.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should be noted that, in some alternative implementations, the functions noted in the block of a figure may occur out of the order noted in the figures. For example, two blocks shown in succession may, in fact, be executed substantially concurrently, or the blocks may sometimes be executed in the reverse order, depending upon the functionality involved.

What is claimed is:

1. A method, the method comprises:
receiving a capture, said capture being captured by a sensor associated with a first computing device, said capture capturing an environment of said first computing device;
identifying a first entity in said capture;
querying, in a data repository, for a second entity said second entity being associated with said computing device; and
transmitting a notification message to be presented in said first computing device, said message notifying a presence of said first entity in said surrounding, said message comprising said identification of said first entity; said transmitting being as a result of identifying a match between a first profile of said first entity and a second profile of said second entity.

2. The method of claim 1 further comprising providing statistics associated with said match.

3. The method of claim 1 wherein said match being performed only if said first entity being authenticated.

4. The method of claim 1 further comprising generating a heat map said heat map comprises a location of said computing device associated with said match.

5. The method of claim 1 wherein said first computing device being a robot.

6. The method of claim 1 wherein said computing device being smart glasses.

7. The method of claim 1 wherein said second entity being a pursuer.

8. The method of claim 1 wherein said

9. A system, the system comprises a sensor and a processing unit; said sensor is configured for capturing a capture of a surrounding of said apparatus; wherein said processing device is configured for receiving said capture for identifying a first entity in said capture; for querying, in a data repository, for a second entity said second entity being associated with said computing device; and for transmitting a notification message to be presented in said first computing device, said message notifying a presence of said first entity in said surrounding, said message comprising said identification of said first entity; said transmitting being as a result of identifying a match between a first profile of said first entity and a second profile of said second entity

10. At least one non-transitory computer-readable storage medium having stored thereon instructions that, when executed by one or more processors, cause the one or more processors to perform operations comprising: receiving a capture, said capture being captured by a sensor associated with a first computing device, said capture capturing an environment of said first computing device; identifying a first entity in said capture; querying, in a data repository, for a second entity said second entity being associated with said computing device; and transmitting a notification message to be presented in said first computing device, said message notifying a presence of said first entity in said surrounding, said message comprising said identification of said first entity; said transmitting being as a result of identifying a match between a first profile of said first entity and a second profile of said second entity.
